(19) United States
(12) Patent Application Publication
(10) Pub. No.: US 2009/0289742 A1
(43) Pub. Date: Nov. 26, 2009

(54) WAVEGUIDE COUPLER

(76) Inventor: Nobuhiko Oguma, Tokyo (JP)

Correspondence Address: Mr. Jackson Chen, 6535 N. STATE HWY 161, IRVING, TX, 75039, US

(21) Appl. No.: 12/294,408

(22) PCT Filed: Mar. 31, 2007
(86) PCT No.: PCT/JP2007/054993

§ 371 Date: Sep. 24, 2008

(30) Foreign Application Priority Data
Mar. 31, 2006 (JP) 2006-097234

(51) Int. Cl. H01P 5/12

(52) U.S. Cl. 333/137

(57) ABSTRACT

The present invention provides a waveguide coupler capable of attaining high electrical characteristics and high productivity.

The waveguide coupler 10 of the present invention includes four ports 1 to 4, and grooves 21 to 24 provided along a waveguide wall in the vicinity of a joint. The grooves 21 and 22 are formed along inner walls and the grooves 23 and 24 are formed along outer walls. By forming grooves along the waveguide wall, the same function as a case where a ridge exists in the vicinity of the joint can be served and therefore bandwidth of various frequency characteristics can be widened, thus attaining high electrical characteristics in various frequency menus. Further, cutting grooves provides higher manufacturing workability than forming a ridge and increase the way of grooving, thereby attaining high cost performance and high productivity.

### TECHNICAL FIELD

The present invention relates to a waveguide coupler.

### BACKGROUND ART

Conventional waveguide couplers have, for example, a shape as illustrated in FIG. 1. Even a relatively small type provides good characteristics over a wide bandwidth. However, in recent years, still wider bandwidth has been demanded and it is difficult for conventional waveguide couplers to cope with the demand. Therefore, such improvement in electrical characteristics has been demanded.

Waveguide couplers have various frequency menus. Even waveguide couplers having different frequency menus may use waveguide interfaces of the same size. In such a case, manufacture of one waveguide coupler having wider bandwidth design can provide higher cost performance than manufacture of plural waveguide couplers, which correspond to plural frequency characteristics respectively. Such improvement in productivity has been demanded.

In Patent Document 1, the cutoff frequency of TE10 mode (TE: Transverse electric) is lowered without changing the inside diameter of a waveguide by adding a ridge, thereby widening the bandwidth of frequency characteristics of a waveguide itself. A coupler using such a waveguide also widens frequency characteristics.

In Patent Document 2, the cut-off frequency of TE10 mode or TE20 mode is lowered without changing the inside diameter of a waveguide of a joint by adding a ridge. In this case, however, because of the shape of the ridge, a mode of which the characteristics can be changed is TE20 mode primary, and TE10 mode becomes secondary. Specifically, the frequency characteristics of a coupler itself are widened by adjusting frequency characteristics of TE20 mode against the frequency characteristics of TE10 mode, which can be changed less.

By forming grooves in a waveguide wall of a joint, the present invention provides the same effect as a case where ridges are formed. In addition, according to the present invention, cut-off characteristics of TE10 mode and TE20 mode can be adjusted to be almost equal to each other, depending upon the way of grooving. Accordingly, the number of adjusting methods of frequency characteristics result in increasing and therefore, it is possible to widen the frequency characteristics, as well as to select a waveguide shape for implementing the widened characteristics to be easy to manufacture, thus reducing manufacturing cost of a coupler.

### Patent Document 1: Japanese Utility Model Application Laid-Open No. 03-053007

### Patent Document 2: Japanese Patent Application Laid-Open No. 10-126118

### DISCLOSURE OF THE INVENTION

Problem to be solved by the Invention

In view of the foregoing problems, an exemplary object of the present invention is to provide a waveguide coupler capable of attaining high electrical characteristics and high productivity.

Means for solving the Problem

The exemplary embodiment of the present invention capable of achieving the foregoing exemplary object relates to a waveguide coupler, in which a groove is formed along a waveguide wall in the vicinity of a joint.

The grooves are formed along an inner wall or an outer wall of the waveguide wall. Both sides of side walls of the groove may be formed along the waveguide wall. Otherwise, the groove may be formed in a multi-stage shape.

At least one of the width, position and depth of the grooves in at least one of an input area of an input port of the waveguide coupler and an output area of an output port of the waveguide coupler is adjusted.

### EFFECT OF THE INVENTION

The waveguide coupler of the present invention exhibits the same function as a case where a ridge exists in the vicinity of a joint, by forming grooves along a waveguide. Therefore, wide bandwidth of various frequency characteristics can be achieved, thus enhancing electrical characteristics in various frequency menus. Cutting grooves provides higher manufacturing workability and increases the way of grooving than forming ridges, thereby attaining high cost performance and high productivity.

### BEST MODE FOR CARRYING OUT THE INVENTION

Now, an exemplary embodiment for carrying out a waveguide coupler according to the present invention will be described hereinafter referring to accompanying drawings.

FIG. 2 illustrates a structure of a waveguide coupler 10 according to the exemplary embodiment. The waveguide coupler 10 includes four ports: a port 1, a port 2, a port 3 and a port 4 and grooves 21, 22, 23, 24 extending along waveguide walls in the vicinity of a joint. The grooves 21, 22 are formed along inner walls and grooves 23, 24 are formed along outer walls. The Port 1 and port 2 are input ports for inputting transmitted electromagnetic wave, and port 3 and port 4 are output ports for outputting transmitted electromagnetic wave.

FIG. 3 illustrates a transmitting state of electromagnetic wave performed in the waveguide coupler 10. The grooves 21 to 24 are not illustrated here. By inputting TE10 mode from the port 1 in a region I (1), TE10 mode (2) and TE20 mode (3) are excited in a region II. Further, TE10 mode is excited into port 3 (4) and TE10 mode is excited into port 4 (5) in a region III. FIG. 4 illustrates a waveform of electromagnetic wave of the respective modes (1) to (5).

At this time, since energies in the respective regions I, II and III are equal, an ideal state excluding electric current loss at the waveguide wall or the like can be presented by

$$\begin{matrix}( 1 ) TE 10 mode = ( 2 ) TE 10 mode + ( 3 ) TE 20 mode \\ = ( 4 ) TE 10 mode + ( 5 ) TE 10 mode\end{matrix}$$

TE10 mode at port 3 (4) and TE10 mode at port 4 (5) are almost equal to each other, and the energy input from port 1 is almost equally distributed to port 3 and port 4.

It is a known fact that rectangular waveguides used in respective regions have frequency characteristics and it may be said that the frequency characteristics of the rectangular waveguide dominate the frequency characteristics of the waveguide coupler.

Generally, as means for widening the frequency characteristics of the rectangular waveguide as illustrated in FIG. 5A, there is a ridge waveguide as illustrated in FIG. 5B. The ridge waveguide is provided with a ridge, accordingly, the cut-off frequency of the waveguide is lowered, thus attaining wide frequency characteristics. The present invention is attained by applying the characteristics of the ridge waveguide to a region II in FIG. 3, which is a joint of the waveguide coupler, to widen the coupling characteristics. For application to a product, a connection waveguide, which is capable of arbitrarily changing the shape of a waveguide by connecting with the respective ports 1 to 4 in regions 0, IV, may be provided. An connection waveguide is continuously connected by adjusting at least one of the width, position and depth of the respective grooves 21 to 24 in the regions 0, IV of the ports 1 to 4, that is, an input area of an input port and an output area of an output port.

Implementation of the waveguide coupler 10 according to the exemplary embodiment provides following effects. Referring to FIGS. 6 to 8, the effects thereof will be described in detail below.

FIG. 6 graphs basic characteristics of a conventional waveguide coupler (structured as illustrated in FIG. 1). Coupling amount (S41, S31) is −3.1±0.3 dB at a fractional bandwidth of approximately 10% and return loss (S11, S21) is −24 dB.

FIG. 7 graphs basic characteristics of the waveguide coupler 10 according to the exemplary embodiment. FIG. 8 illustrates an enlarged view of a portion around the coupling amount (S41, S31) in FIG. 7. Coupling amount (S41, S31) is −3.1±0.3 dB at a fractional bandwidth of approximately 26% and return loss (S11, S21) is −21 dB, whereby a waveguide coupler having a wider bandwidth than a conventional one is obtained and then higher productivity can be attained. The grooves 21 to 24 are formed along the waveguide wall in the vicinity of the joint and therefore the grooves serve the same function as a case where a ridge exists in the vicinity of the joint, thus cut-off characteristics of TE10 mode and TE20 mode can be adjusted to almost the same degree. Accordingly, the number of adjusting methods of frequency characteristics results in increasing and therefore, it is possible to widen the frequency characteristics, as well as to select a waveguide shape for implementing the widened characteristics to be easy to manufacture. Accordingly, cutting grooves provides higher manufacturing workability than forming a ridge, and there are more ways of grooving, thus attaining high cost performance and high productivity.

It is apparent that the above exemplary embodiment is a best mode for carrying out the invention but it is not intended to limit the invention to the exemplary embodiment and the exemplary embodiment may be modified and changed without departing from the spirit and scope thereof.

In addition to those illustrated in FIG. 2, frequency characteristics may be changed by making various changes or modifications on positions to make grooves or a quantity of grooves, for example. FIG. 9 illustrates a structure excluding grooves 21, 22 formed along the inner wall in FIG. 2. FIG. 10 illustrates a structure where side walls of grooves 23, 24 formed along outer walls are provided on the sides near outer walls in addition to the sides near inner walls in FIG. 2. FIG. 11 illustrates a structure where grooves 25, 26 having smaller depths are provided in addition to grooves 23, 24 formed along outer walls in FIG. 2 to form multi-stage grooves. Such structures are simply illustrative.

Such structures can serves the same function as the one where a ridge exists in the vicinity of a joint, and thus a bandwidth of frequency characteristics can be more precisely widened in variation and electrical characteristics in various frequency menus can improve. Further the waveguide coupler allows selection of a waveguide shape for implementing the characteristics to be easy to manufacture and therefore manufacturing workability can be enhanced, thus high cost performance and high productivity can be attained.

### BRIEF DESCRIPTION OF THE DRAWINGS

FIG. 1 is a structural view of a conventional waveguide coupler.

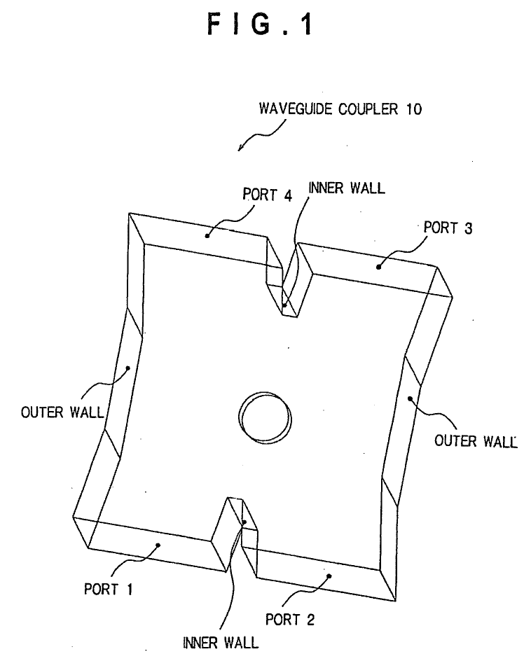

FIG. 2 is a structural view of a waveguide coupler 10 according to the exemplary embodiment.

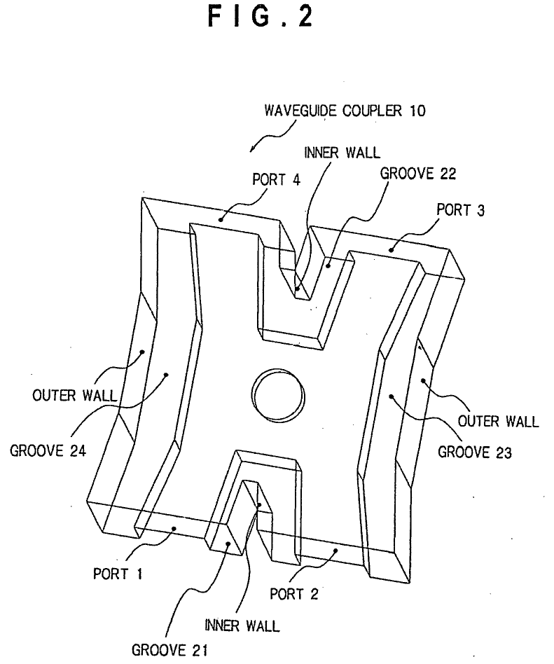

FIG. 3 is a view illustrating a transmitting state of electromagnetic wave performed by a waveguide coupler 10.

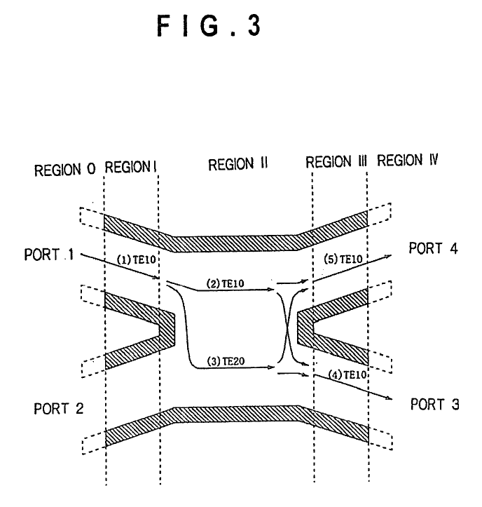

FIG. 4 is a view illustrating the waveform of electromagnetic wave of respective modes (1) to (5).

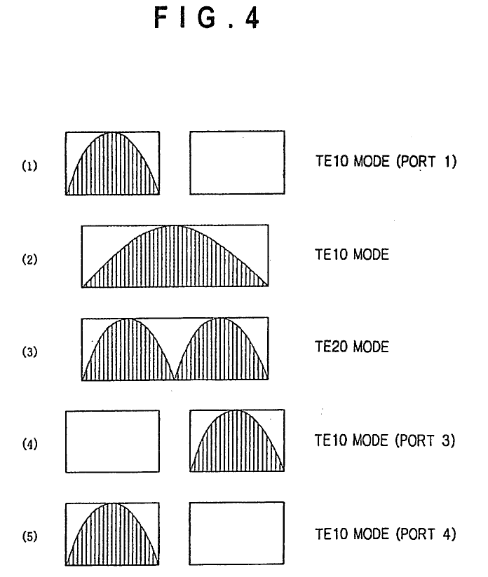

FIG. 5 is a structural view of a rectangular waveguide (a) and a ridge waveguide (b).

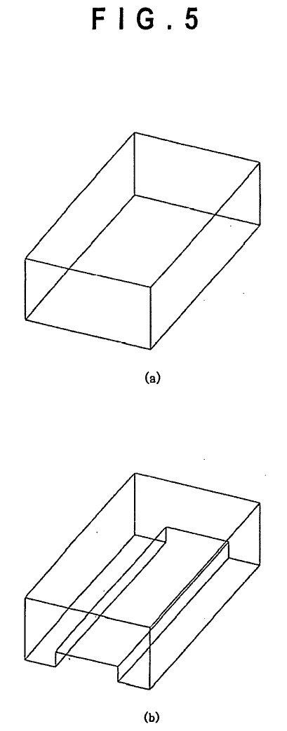

FIG. 6 is a graph of basic characteristics of a conventional waveguide coupler.

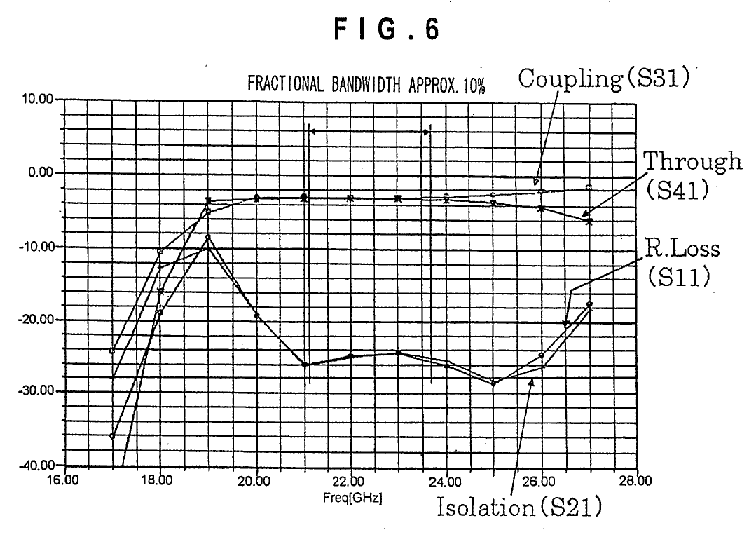

FIG. 7 is a graph of basic characteristics of the waveguide coupler 10 of the exemplary embodiment.

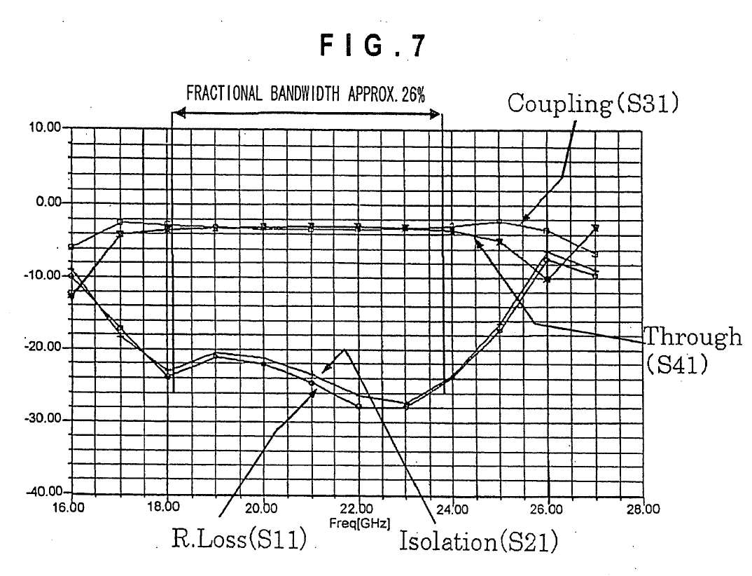

FIG. 8 is a view illustrating an enlarged portion of around the coupling amount (S41, S31) in FIG. 7.

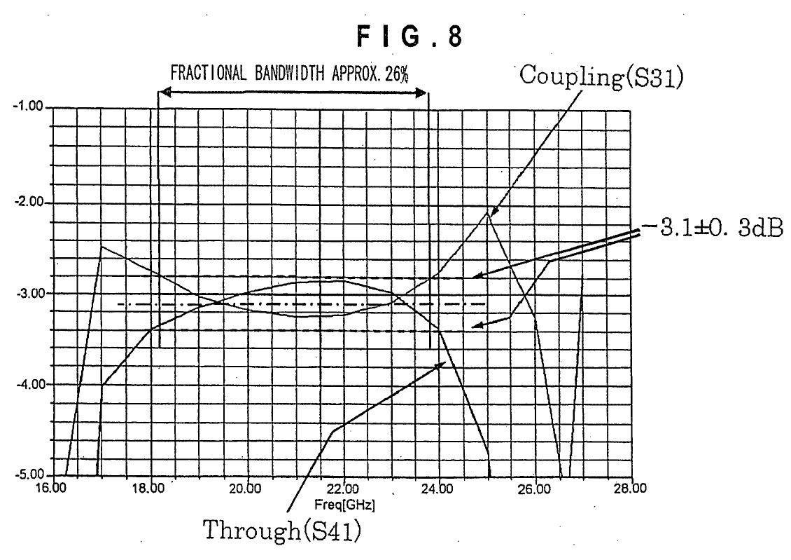

FIG. 9 is a view of another structure of the waveguide coupler 10.

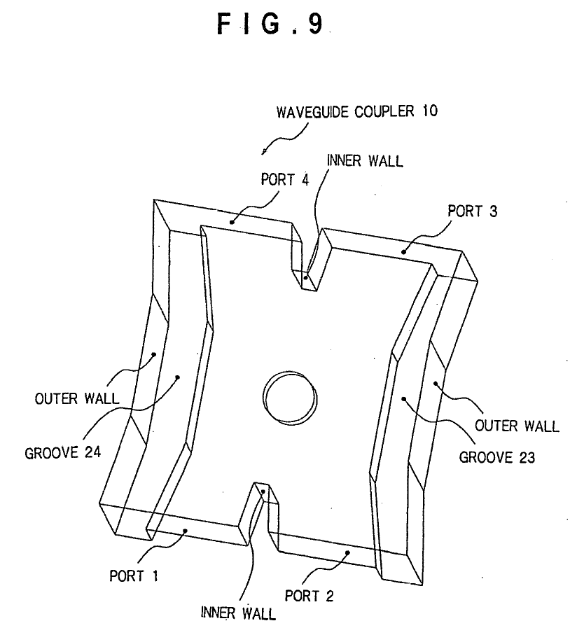

FIG. 10 is a view of another structure of the waveguide coupler 10.

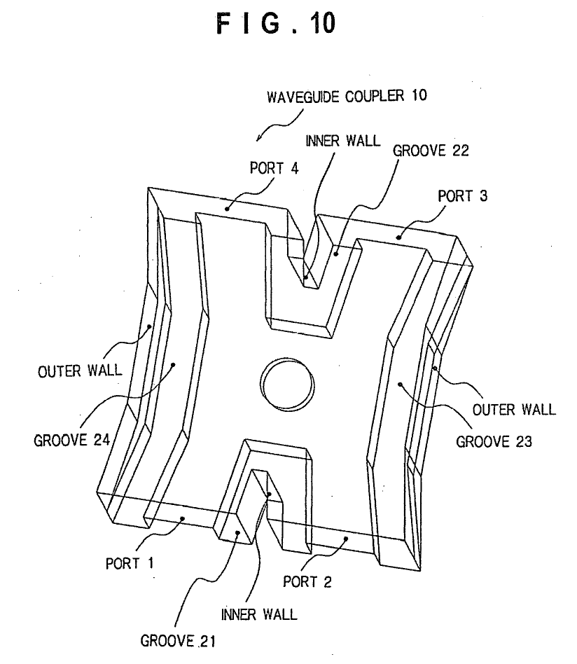

FIG. 11 is a view of further structure of the waveguide coupler 10.

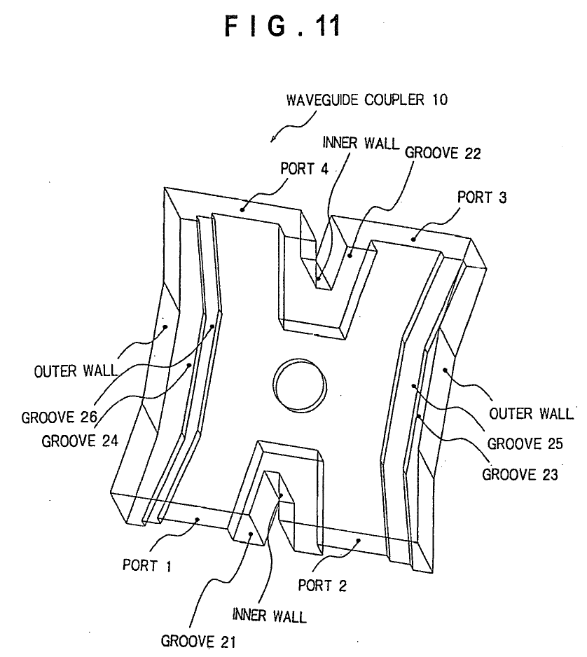

### DESCRIPTION OF THE REFERENCE NUMERALS

10 waveguide coupler

1, 2, 3, 4 port

21, 22, 23, 24, 25, 26 groove

1. A waveguide coupler, wherein a groove is formed along a waveguide wall in the vicinity of a joint.

2. The waveguide coupler according to claim 1, wherein the groove is formed along an inner wall of the waveguide wall.

3. The waveguide coupler according to claim 1, wherein the groove is formed along an outer wall of the waveguide wall.

4. The waveguide coupler according to claim 1, wherein both sides of side walls of the groove are formed along the waveguide wall.

5. The waveguide coupler according to claim 1, wherein the groove is formed into a multi-stage shape.

6. The waveguide coupler according to any one of claims 1, wherein at least one of the width, position and depth of the groove in at least one of an input area of an input port of the waveguide coupler and an output area of an output port of the waveguide coupler is adjusted.
